(19) United States
(12) Patent Application Publication
(10) Pub. No.: US 2009/0149697 A1
(43) Pub. Date: Jun. 11, 2009

(54) Length-variable auditory ossicle prosthesis

(76) Inventors: Uwe Steinhardt, Hirrlingen (DE); Heinz Kurz, Dusslingen (DE)

Correspondence Address: FLYNN THIEL BOUTELL & TANIS, P.C., 2026 RAMBLING ROAD, KALAMAZOO, MI, 49008-1631, US

(21) Appl. No.: 12/231,326

(22) Filed: Aug. 29, 2008

(30) Foreign Application Priority Data
Aug. 31, 2007 (DE) 10 2007 041 539.9

(51) Int. Cl. H04R 25/00

(52) U.S. Cl. 600/25

(57) ABSTRACT

An auditory ossicle prosthesis with a first and a second securing element for mechanical securement in the middle ear as well as a connecting element, which is rigidly connected to the securing elements and connects them to each other and has a receiving part and a push-in part that can be pushed into a receiving opening of the same, the connecting element being designed so as to be variable in length in the axial direction between the receiving part and the push-in part, and it being possible for the receiving part and the push-in part to be clamped in a desired relative coaxial pushed-in position, characterized in that the clamping force F_{K} between the receiving part and the push-in part in the clamped state is at least 10 times, preferably approximately 100 times, greater than the maximum external forces naturally occurring in the middle ear in the region of the ossicles. In this way it is possible in a simple manner for a desired, defined length of the prosthesis to be established even before it is clamped in between the two securing points, and for this length to be maintained exactly with a lasting effect even after completion of the operation, for example after the insertion of a second securing element, formed as a piston, through a perforated stirrup footplate.

### BACKGROUND OF THE INVENTION

The invention relates to an auditory ossicle prosthesis which replaces or spans at least one member of the ossicular chain in humans, the auditory ossicle prosthesis comprising at one end a first securing element for mechanical connection to the eardrum or a member of the ossicular chain, in particular to the process of the anvil or to the manubrium of the hammer, and at its other end a second securing element for mechanical connection to a further member or parts of a member of the ossicular chain or directly to the inner ear, and also comprising an elongate connecting element, which connects the two securing elements to each other in a sound-conducting manner and has a first piece, which is formed as a receiving part, and a second piece, which is formed as a push-in part that can be pushed into a receiving opening of the receiving part coaxially in relation to the longitudinal axis of the connecting element, the first securing element being connected mechanically rigidly to one end and the second securing element being so connected to the axially opposite other end of the connecting element, the connecting element being designed so as to be variable in length in the axial direction between the receiving part and the push-in part, and the fixing of the actual axial length of the connecting element of an individual auditory ossicle prosthesis being performed by clamping the push-in part with the receiving part in a desired relative coaxial pushed-in position.

Such a device is known from US 2003/0097178 A1.

The human middle ear with its ossicles has the task of transmitting the sound waves impinging on the eardrum by way of the outer auditory canal to the inner ear filled with fluid. The three ossicles are the hammer (Latin malleus), which is secured to the eardrum, the stirrup (Latin stapes), which is connected to the inner ear by way of its footplate (Latin basis stapedis), and the anvil (Latin incus), which is located between the hammer and the stirrup and is jointedly connected to them. Otosclerosis, for example, is a disorder of the human petrosal bone (=bone in which the entire ear is seated) in which bone remodeling processes similar to inflammation can cause the normally freely oscillating stirrup to become fixed. As a result, the sound signal is not transmitted, or only incompletely, by way of the ossicular chain to the inner ear, which leads to impaired hearing.

Auditory ossicle prostheses are used to improve the sound transmission in various cases of pathological findings. They are used to transmit the sound from the eardrum to the inner ear in cases where ossicles of the human middle ear are entirely or partially absent or damaged. The auditory ossicle prosthesis has in this case two ends, one end of the auditory ossicle prosthesis being secured for example by means of a headplate to the eardrum and the other end of the auditory ossicle prosthesis being secured for example to the stirrup of the human ossicular chain or inserted directly into the inner ear, depending on the actual circumstances encountered. Often, the sound conduction between the eardrum and the inner ear is made possible only to a limited extent with the known auditory ossicle prostheses, because they can only replace the natural anatomical formations of the ossicular chain to a very limited extent.

Three types of auditory ossicular prosthesis that are used particularly frequently are stirrup prostheses, partial prostheses and total prostheses. Stirrup prostheses (=stapes prostheses) are fixed to the anvil and protrude by way of a piston into the inner ear. Partial prostheses usually lie with a headplate against the eardrum and establish a connection with the head of the stirrup. Total prostheses connect the eardrum to the foot of the stirrup.

A major problem that occurs in any reconstruction of the human ossicular chain is that of choosing the correct length of the prosthesis. For anatomical reasons, the lengths respectively required vary within a range of several millimeters. Therefore, when an auditory ossicle prosthesis is fitted in a surgical operation, either an adequately large selection of prostheses of different axial lengths must be kept available or it must be possible during the operation for the auditory ossicle prostheses that are used to be brought to the required final axial length from a maximum starting length.

WO 92/18066 A1 describes a self-adaptable auditory ossicular prosthesis which has in the connection between the first securing element and the second securing element a complicated and difficult-to-produce spring mechanism, which brings about continual changing of the axial length of the prosthesis according to the relative position of the securing points in the middle ear. A reproducibly exact, fixed length setting of the prosthesis that is also maintained after surgical fitting of the same in the inner ear is not possible in this way. Moreover, because of its very specific mechanical and geometrical structure, the known prosthesis requires considerable space in the middle ear, so that in many cases it cannot be used at all on account of the individual circumstances encountered in the patient. Furthermore, for structural design reasons, after fitting, a not inconsiderable permanent pressure is built up between the two securing points in the middle ear, which is not exactly conducive to healing after the operation and, in the long term, often leads to postoperative complications.

An auditory ossicle prosthesis with an axial length that is variable within certain limits during the operation is described in DE 39 01 796 A1. In this case, the change in length is achieved by bending the connecting element, which is produced more thinly from gold wire, which however is on the one hand awkward to handle and on the other hand quite imprecise, so that exact fixing of the desired axial length of the auditory ossicle prosthesis cannot be achieved in this way. Furthermore, with this technique, the result is not always reproducible and it may happen that, after the bending of the connecting element, the axial length of the auditory ossicle prosthesis that has been set changes again due to springing back of the connecting element.

EP 0 998 884 A2 describes an auditory ossicle prosthesis in which the first connecting element, formed as an elongate shaft, is inserted through a through-hole of the first securing element, formed as a headplate, until a desired shaft length between the first securing element and the second securing element is achieved. Then, the shaft is fixed in this position by constricting the through-hole in the headplate and the part of the shaft that is projecting beyond the headplate is cut to length. In this way, a prosthesis with the respectively desired or required axial length, a length which, in particular, remains exactly the same after the operation, is obtained in a simple manner.

DE 10 2005 010 705 B3 discloses an auditory ossicle prosthesis in which intraoperative variability of the length of the prosthesis is achieved by the element taking the form of a chain of balls. During the operation, this is inserted with a certain number of balls through a receiving opening of the first securing element. After that, the chain of balls is fixed in the receiving opening of the securing element by resilient web elements acting on both sides of the chain of balls and the projecting part of the chain of balls that is protruding through the receiving opening being twisted off, so that the prosthesis finally has at the end precisely the desired axial length. In a similar way, length variability is also achieved in the case of an auditory ossicle prosthesis according to DE 20 2005 015 944 U1, once again a chain of balls that can be twisted off being used as the connecting element, but the way in which it is received in the first securing element being differently designed.

A further auditory ossicle prosthesis with intraoperatively variable axial length is described in U.S. Pat. No. 3,710,399. Here, a connecting element divided in two and comprising two parallel-running straight pieces of wire, one of which extends away from the first securing element and the other extends away from the second securing element, is used between the two securing elements. The two pieces of wire may either be connected by means of wire loops at their ends to the other piece of wire, respectively, or be inserted into a kind of connecting sleeve with two parallel longitudinal holes for the two pieces of wire.

In the first case, however, the fixing position, and consequently the relative position, of the two pieces of wire can be set only very imprecisely, so that an exact and reproducible length setting of the prosthesis is not possible. In the second case, it is easily possible after the insertion of the pieces of wire into the connecting sleeve for instances of tilting, buckling or displacement of the relative positions of the pieces of wire to occur, likewise making an exact setting of the axial length of the prosthesis more difficult or impossible.

Once again, a different technique of length setting is used in the case of an auditory ossicle prosthesis such as that known from DE 10 2005 027 215 A1. This prosthesis is aimed exclusively at the situation of a stirrup operation, so that a plunger-shaped piston is always provided as the second securing element. Arranged in this piston is a receiving mechanism, into which the connecting element in shaft form is intended to be pushed in axially. Leaf springs that are spread apart radially by the connecting element are then intended to bring about arrestment in a desired relative position between the connecting element and the second securing element. Apart from the fact that exactly reproducible setting of a desired axial length of the prosthesis may well not always be ensured in this way, the application area for this auditory ossicle prosthesis is confined only to stirrup operations, in which a direct connection with the inner ear is established by way of the piston. If, however, a bell, a punch, a clip or a flat shoe is to be used as the second securing part for a connection to another part of the ossicular chain, this known prosthesis cannot be used. This is so because, if it is wished to accommodate a corresponding receiving mechanism in the second securing part, geometrical reasons alone mean that this only works in a piston, but never in a bell or a flat shoe, let alone a clip.

A further auditory ossicle prosthesis is described in U.S. Pat. No. 5,554,188 and once again comprises a connecting element constructed as a shaft that is divided in two, in which the first portion, in rod form, can be inserted into a receiving hole of the second portion, formed as a receiving part, and can be axially displaced in the hole. In order to obtain a desired axial length of the prosthesis, the first portion in rod form is cut off from a maximum starting length to a suitable final length and pushed into the second portion as far as it will go. By making the receiving hole have an appropriate clear diameter in relation to the outside diameter of the first portion, frictional clamping of the first and second portions is then intended to bring about a certain fixing of the length of the prosthesis, the actual fixing being achieved by the fact that the parts of the prosthesis that are movable with respect to one another cannot move very far away from one another after a surgical insertion into the middle ear on account of the way in which they respectively butt against the two securing points. However, a prosthesis length that remains exactly the same cannot be ensured in this way with a lasting effect.

The auditory ossicle prosthesis such as that described in the initially cited US 2003/0097178 A1 has a mechanical construction similar to that of the prosthesis discussed above according to U.S. Pat. No. 5,554,188. In addition, however, it is designed not only as a self-acting passive element, but also as “partially active”, and may comprise a photothermal micropump with moving fluid, by means of which it is intended to achieve an automatic length adjustment of the prosthesis.

### SUMMARY OF THE INVENTION

The object of the present invention is to improve in comparison an auditory ossicle prosthesis of the generic type described at the beginning with the simplest possible technical means to the extent that a desired, defined length of the prosthesis can be established even before it is clamped in between the two securing points, and that this length is maintained dependably and unchangingly even after completion of the operation, for example after the insertion of a second securing element, formed as a piston, through a perforated stirrup footplate.

This object is achieved according to the invention in a way that is as surprisingly simple as it is effective, by it being possible to design an auditory ossicle prosthesis of the generic type with the features described at the beginning in such a way with regard to its geometrical structure and by the choice of its material that the clamping force F_{K} between the receiving part and the push-in part in the clamped state is at least 10 times, preferably approximately 100 times, greater than the maximum external forces naturally occurring in the middle ear in the region of the ossicles.

The latter forces admittedly vary somewhat according to the anatomy and age of a patient. The above requirement that the clamping force F_{K} is to be at least 10 times, preferably approximately 100 times, greater than the maximum external forces naturally occurring in the middle ear in the region of the ossicles nevertheless provides a person skilled in the art in the field of otology with a defined lower estimate for the clamping force F_{K} between the receiving part and the push-in part in the clamped state:

As revealed by the specialist article HNO 3 2000 48 : 204-208, the human middle ear still functions “normally” when a force of 2.5 mN is applied, while a considerable decrease in the oscillation amplitude of the stirrup footplate is observed when a prosthesis is clamped in place with a force of 15 mN. It follows from this that the human middle ear is obviously only “designed” for operating under loads below 15 mN.

In the specialist article Larygo-Rhino-Otol 2007; 86 : 112-116, it is shown that, by applying forces from 290 mN and above to the stirrup footplate, fractures of the stirrup footplate are observed. According to the study, the maximum permissible forces under which it was still just possible for no fracture of the stirrup footplate to occur lay below 250 mN.

It is consequently clear that the maximum external forces naturally occurring in the middle ear in the region of the ossicular chain—irrespective of the anatomy and age of a patient—may lie in the range of at most approximately 15 mN, possibly even a little above (perhaps approximately 25 mN), in order for the middle ear to function “normally”. The forces must not, however, under any circumstances reach the order of magnitude of 250 mN. Otherwise, spontaneous fractures of the stirrup footplate would frequently occur “during operation” of the middle ear and the human middle ear would consequently become a severe case of “bad design”—which is obviously not the case.

Therefore, to a person skilled in the art, the requirement according to the invention of “at least 10 times, preferably approximately 100 times, greater than the maximum external forces naturally occurring in the middle ear in the region of the ossicles” clearly means: “choose a force greater than 250 mN, preferably greater than 2.5 N”.

Subsequent postoperative undesired changes in length and/or position of the prosthesis are avoided with a lasting and dependable effect by this prescribed choice according to the invention of the clamping force F_{K}.

Keeping to the teaching according to the invention that is described above makes it possible to obtain a genuine length variability of the auditory ossicle prosthesis “in situ” or intraoperatively in an uncomplicated and inexpensive manner, without large ranges of prosthesis of different lengths having to be kept available during every operation. Furthermore, the setting of the respectively desired individual length of the prosthesis, and consequently its handling, are particularly simple. As a result, the advantages of the known auditory ossicle prosthesis described above, according to the generic US 2003/0097178 A1, are used in a simple way, while also retaining however the advantages of the length-variable prostheses described in the other documents cited above and avoiding the disadvantages they have in common.

Moreover, the auditory ossicle prosthesis according to the invention can be used universally for all conceivable types of couplings in the middle ear space and is not restricted to one specific class of operations, whereas, for example, the prosthesis according to DE 10 2005 027 215 A1, cited above, can only be used in the situation of a stirrup operation.

In the case of one class of embodiments of the invention, the push-in part can be continuously clamped in different coaxial positions, preferably along a predetermined axial distance in any desired relative coaxial position, with the receiving part, so that consequently any desired length of prosthesis below the maximum length prescribed by the basic model of the prosthesis can be individually set exactly.

An alternative class of embodiments is distinguished by the fact that the push-in part can be clamped in selectable discrete relative coaxial positions along an axial distance with the receiving part, which facilitates the intraoperative handling of the auditory ossicle prosthesis in comparison with continuous displaceability, but in return of course only allows settings to the discrete lengths prescribed by the basic model of the prosthesis.

Particularly easy to handle are developments of this class of embodiments in which the push-in part can be clamped in the chosen relative coaxial clamping position in engagement with the receiving part, so that the prosthesis remains fixed in the desired and set length, and so can be positioned between the securing points in the middle ear.

In the case of a further class of embodiments of the auditory ossicle prosthesis according to the invention, the push-in part can be passively clamped with the receiving part by means of a spring action of the push-in part of its own and/or a spring action of the receiving part of its own.

As an alternative to this, however, in the case of a further class of embodiments of the invention, the push-in part may however also be designed such that it can be actively clamped with the receiving part by means of an external effect acting on the push-in part and/or on the receiving part. In simple developments of these embodiments, the push-in part may be able to be actively clamped with the receiving part by the effect of force acting from outside, in particular by means of the effect of the action of a crimping tool.

In the case of more elegant developments, which however are in return somewhat more difficult to produce, it is provided that the push-in part can be actively clamped with the receiving part by introducing heat to the auditory ossicle prosthesis from the outside, in particular by means of heating the auditory ossicle prosthesis to body temperature.

Most particularly advantageous are variants of these developments in which the push-in part and/or the receiving part is/are produced completely or partially from a material with shape memory (=memory effect), in particular from nitinol. The use of such materials is known per se in the field of auditory ossicle prostheses, but proves to be particularly effective specifically in connection with the present invention.

A geometrically and ergonomically favorable embodiment of the auditory ossicle prosthesis according to the invention is distinguished by the fact that the push-in part has a thickening, preferably arranged at its axial end toward the receiving part.

Successfully proven in practice are developments of this embodiment in which the thickening has an ellipsoidal, in particular a rotational-ellipsoidal, preferably a spherical form. These geometries also do not present any major problems in terms of production engineering.

Particularly simply and compactly constructed, and therefore to be preferred, are embodiments of the invention that are distinguished by the fact that the receiving part has an elongate hollow space that is open in the direction of the push-in part and extends in the axial direction of the connecting element.

In the case of one class of developments of these embodiments, the elongate hollow space of the receiving part may be closed on one side in the direction away from the push-in part and thereby have an end stop for the push-in part.

Alternatively, however, these embodiments may also be developed to the extent that the elongate hollow space is open on both sides in the axial direction of the receiving part.

In this case, the elongate hollow space may have a cylindrical, preferably circular-cylindrical form, or in the case of other variants of the invention a conical or pyramidal form and preferably taper away from the push-in part in the axial direction. Also possible, however, are variants in which the elongate hollow space has a rectangular cross-sectional form perpendicularly to the longitudinal axis of the receiving part, which may have production-engineering advantages, depending on the choice of material.

Most particularly simple in their handling are developments in which the connecting element comprises a clamping part which at least partially surrounds the receiving part in a clamping position, which corresponds to the desired relative coaxial pushed-in position between the push-in part and the receiving part, and in this clamping position at least locally constricts the inside diameter of the elongate hollow space in the receiving part.

Depending on the desired application area of the auditory ossicle prosthesis according to the invention, these developments can then have mechanically very different specific forms: for instance, the clamping parts may be constructed in the manner of a clamp, collar, sleeve, clip, clasp, clamping ring or strap. The basic concept of the present invention can consequently be used quite universally in the area of middle ear prosthetics.

In the case of specific refinements of the invention, the clamping part can be pushed over the receiving part coaxially from the outside.

However, refinements representing an alternative to this, in which the clamping part can be applied to the receiving part transversely to the longitudinal axis of the receiving part, may also be advantageous.

These refinements can once again be produced particularly simply if the clamping part is slit continuously on one side parallel to the longitudinal axis of the receiving part.

In the case of a most particularly preferred development of the embodiments described above, the receiving part has on at least one side an elongate window that runs parallel to its longitudinal axis, is formed as a clearance up to the elongate hollow space and, in the inserted state of the push-in part in the receiving part, affords a view of the push-in part, and thereby makes it possible for the auditory ossicle prosthesis to be set to the desired axial length in a simple and exact manner.

This development can be still further improved by a measuring scale being arranged alongside the elongate window, parallel to the longitudinal axis of the receiving part, which scale preferably has scale divisions, preferably running transversely to the longitudinal axis of the receiving part, in particular equidistant scale divisions, which allows the desired length of the prosthesis to be set intraoperatively and particularly exactly.

Embodiments of the auditory ossicle prosthesis according to the invention in which the receiving part has a rectangular outer contour in its cross section, perpendicularly to it longitudinal axis, make production considerably easier in comparison with cylindrical components.

Most particularly easy and inexpensive to produce are developments of these embodiments in which the receiving part is produced from sheet metal.

Once the prosthesis has been surgically placed in the middle ear and the eardrum closed again, what is known as the healing phase begins. In this time, scars form and these unpredictably cause forces that may lead to the prosthesis being displaced from its local position. With a rigid connection between the headplate and the shaft, increased pressure peaks may occur between the edge of the headplate and the eardrum or the transplant between the eardrum and the headplate. These peaks may be so high that penetration or extrusion through the eardrum would be the consequence. For this reason, it is very helpful if the prosthesis has a certain postoperative mobility, so that the headplate can postoperatively adjust itself of its own accord to the position of the eardrum. Since, moreover, the anatomical circumstances encountered in the ear, such as for example the position, the form and the size of the stirrup, the anvil, the hammer and the eardrum, vary, it is very advantageous if auditory ossicle prostheses are not rigidly formed but have a certain flexibility or variability.

In the case of the auditory ossicle prosthesis according to the invention, the connecting element between the two securing elements is generally designed as an elongate shaft, as is well known per se from the prior art. In order to achieve the aforementioned increased flexibility or variability of the prosthesis—as described for example in detail in EP 1 181 907 B1—in the case of a particularly preferred embodiment of the invention at least one ball joint may be provided on or in the elongate shaft. Advantageous with regard to a particularly high degree of postoperative mobility of the prosthesis are developments in which the elongate shaft comprises a multiplicity of further, mutually adjacent rotary elements, preferably a ball joint chain.

Depending on the individual defect to be remedied, or at least mitigated in its effects, in a patient by the fitting of the auditory ossicle prosthesis according to the invention, the construction of the prosthesis is correspondingly designed. In all the embodiments of the invention, the first securing element comprises a headplate formed for lying against the eardrum. In the case of many embodiments, the prosthesis may, for example, on the one hand be secured to the process of the anvil or to the stirrup or be inserted directly into the inner ear. Advantageous in this connection is a refinement in which the auditory ossicle prosthesis is arranged at the end point of the hammer (=umbo) or directly alongside it, whereby the greatest lever effect is achieved for the mechanical transmission of the sound by movements in the artificial or natural ossicular chain.

One class of embodiments of the auditory ossicle prosthesis according to the invention is distinguished by the fact that the second securing element is formed as a plate, as a sleeve, as a loop, as a closed bell, as a singly or multiply slit bell or as a clip for mechanical connection to a further member of the ossicular chain.

In the case of developments of these embodiments, the prosthesis is secured on the one hand to the eardrum by way of the headplate and on the other hand to the anvil or to the stirrup by way of the second securing element.

Alternative refinements may provide that the auditory ossicle prosthesis is coupled at its end carrying the second securing element directly to the inner ear, in particular by way of a piston, by means of perforation of the stirrup footplate (=stapedectomy or stapedotomy) and/or by means of opening up the cochlea (=cochleotomy).

Apart from postoperative positional displacement, a further problem also arises after the implantation of auditory ossicle prostheses, which is that the middle ear of the human body represents a “half open bearing”. As a result, any implantation material that is introduced into the body as part of a reconstruction of the middle ear and its structures undergoes particular stress due to the fact that a contaminated and infected environment prevails, generally attacking the material. Since the aim of the implantation of an auditory ossicle prosthesis must always also be for the implant to remain in the patient's middle ear for as long as possible without any complications, a sustained attack on the material can lead to the prosthesis becoming damaged and/or to local infection. Both consequences are intolerable. To prevent damage both to the implantation material and to the surrounding tissue with a lasting effect, in the case of a further particularly preferred embodiment of the invention the surface of the auditory ossicle prosthesis is covered entirely or at least in certain portions with a biologically active coating, in particular a growth-inhibiting and/or a growth-promoting and/or antibacterial coating.

In principle, the headplate of the auditory ossicle prosthesis according to the invention should have a growth-promoting coating, whereas a second securing element, leading directly into the inner ear and formed for instance as a piston, should have a growth-inhibiting coating.

The auditory ossicle prosthesis according to the invention itself or parts thereof may be produced from titanium and/or from gold and/or from tantalum and/or from steel and/or from an alloy of the metals mentioned. In particular, along with its strength and excellent sound-conducting properties, the material titanium is also known to have outstanding biocompatibility with the human middle ear.

Advantageous with regard to the aforementioned postoperative positional adaptation are embodiments of the invention in which the prosthesis or parts thereof, in particular one of the securing elements, is/are produced from a material with shape memory (=memory effect) or superelastic properties, preferably from nitinol, which is known per se, for example from WO 02/069850 A1 or U.S. Pat. No. 6,554,861 B2.

Alternatively or in addition, in the case of further embodiments parts of the auditory ossicle prosthesis according to the invention may be produced from a ceramic material.

Also possible, however, are embodiments of the invention in which the entire prosthesis or parts thereof is/are produced from biocompatible plastics, in particular silicone, polytetrafluoroethylene (PTFE) or fiber composite materials. With these materials, postoperative rejection reactions can in most cases likewise be prevented.

Particularly preferred is an embodiment of the auditory ossicle prosthesis according to the invention in which the mass distribution of the individual parts of the prosthesis is calculated in dependence on a desired, prescribable frequency response of the sound conduction in the middle ear. This allows tuning of the sound propagation properties to be achieved to a certain extent by means of an individually configured auditory ossicle prosthesis, without great additional technical expenditure.

Such a tuning effect can be achieved in the case of special embodiments, for instance by at least one additional mass being secured to part of the ossicular chain or the prosthesis in dependence on a desired, prescribable frequency response of the sound conduction in the middle ear. In the case of advantageous developments of these embodiments, the additional mass is secured to part of the ossicular chain or the prosthesis by means of a clip. Furthermore, the additional mass and/or the clip may likewise be covered with a biologically active coating.

Finally, a further embodiment of the invention is distinguished by the fact that the prosthesis is connected to an active vibrational part of an active, in particular implantable hearing device. In this way, further hearing damage can also be largely remedied, or at least significantly mitigated in its effects, by use of modern electronics, a physical connection of the prosthesis to the outside world on account of the coating described above once again not causing any problems resulting from increased bacterial ingress into the region of the middle ear if the coating is made appropriately antibacterial.

Further features and advantages of the invention emerge from the following detailed description of exemplary embodiments of the invention on the basis of the figures of the drawing, which shows details that are essential to the invention, and also from the claims. The individual features may each be individually realized in themselves or be realized together in any desired combinations in variants of the invention.

Exemplary embodiments of the invention, which are explained in more detail in the description which follows, are represented in the schematic drawing.

### BRIEF DESCRIPTION OF THE DRAWINGS

FIG. 1a shows a schematic three-dimensional representation of a first embodiment of the auditory ossicle prosthesis according to the invention with a clip as the first securing element and a bell as the second securing element;

FIG. 1b shows the embodiment as shown in FIG. 1a in a side view in a radial direction in relation to the elongate connecting element;

FIG. 1c shows the embodiment as shown in FIG. 1a in a vertical longitudinal section through the auditory ossicle prosthesis;

FIGS. 2a-c show an embodiment with an eardrum headplate as the first securing element and a piston as the second securing element as well as with a window in the receiving part and a measuring scale along the window; and

FIGS. 3a-c show an embodiment with a clip as the first securing element and a piston as the second securing element as well as with a ball joint integrated in the elongate connecting element.

### DESCRIPTION OF THE PREFERRED EMBODIMENTS

The three embodiments of the auditory ossicle prosthesis 10; 20; 30 according to the invention—differently designed in detail—that are schematically represented in the figures of the drawing in each case have at one end a first securing element 11; 21; 31, which serves for mechanical connection of the prosthesis to the eardrum or a member of the ossicular chain. At the other end of the auditory ossicle prosthesis 10; 20; 30 there is in each case a second securing element 12; 22; 32 for mechanical connection of the prosthesis to a further member or parts of a member of the ossicular chain or for direct insertion into the inner ear. Arranged in between is a connecting element 13; 23; 23, which connects the two securing elements 11; 21; 31 and 12; 22; 32 to each other in a sound-conducting manner and in the case of all the embodiments shown in the drawing is configured in the form of an elongate shaft.

The connecting element 13; 23; 33 in each case comprises a first piece, which is formed as a receiving part 14; 24; 34, and a second piece, which is formed as a push-in part 15; 25; 35 that can be pushed into a receiving opening of the receiving part 14; 24; 34 coaxially in relation to the longitudinal axis of the connecting element 13; 23; 33, the first securing element 11; 21; 31 being connected mechanically rigidly to one end and the second securing element 12; 22; 32 being so connected to the axially opposite other end of the connecting element 13; 23; 33.

According to the invention, the connecting element 13; 23; 33 is designed so as to be variable in length in the axial direction between the receiving part 14; 24; 34 and the push-in part 15; 25; 35, the fixing of the axial length of the connecting element 13; 23; 33 of an individual auditory ossicle prosthesis 10; 20; 30 being performed by clamping the push-in part 15; 25; 35 with the receiving part 14; 24; 34 in a desired relative coaxial pushed-in position, and the clamping force F_{K} between the receiving part 14; 24; 34 and the push-in part 15; 25; 35 in the clamped state being at least 10 times, preferably approximately 100 times, greater than the maximum external forces naturally occurring in the middle ear in the region of the ossicles.

In order to bring about this clamping, in the case of the embodiments represented in the drawing the push-in part 15; 25; 35 in each case has a thickening 16; 26; 36 arranged at its axial end toward the receiving part 14; 24; 34. This thickening can be inserted into an elongate hollow space 17; 27; 37 of the receiving part 14; 24; 34 that is open in the direction of the push-in part 15; 25; 35 and extends in the axial direction of the connecting element 13; 23; 33. The desired clamping effect is achieved by the clear inside diameter of the hollow space 17; 27; 37 being chosen to be somewhat smaller than the outside diameter of the thickening 16; 26; 36. In the case of all the embodiments shown, the elongate hollow space 17; 27; 37 of the receiving part 14; 24; 34 is closed on one side in the direction away from the push-in part 15; 25; 35 and thereby forms an end stop for the push-in part 15; 25; 35.

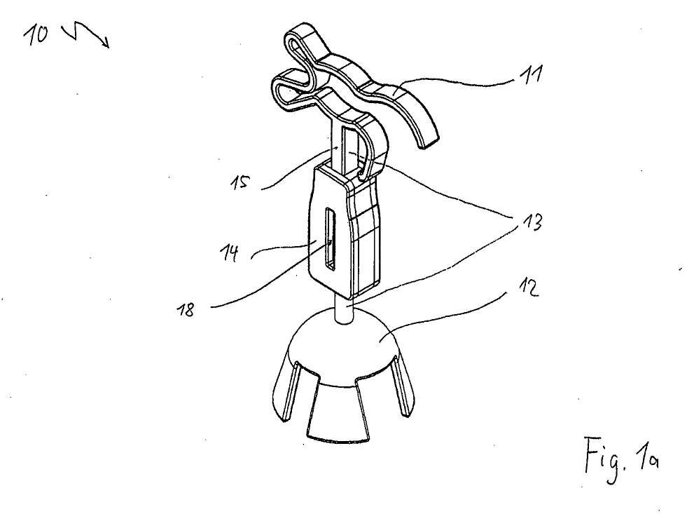

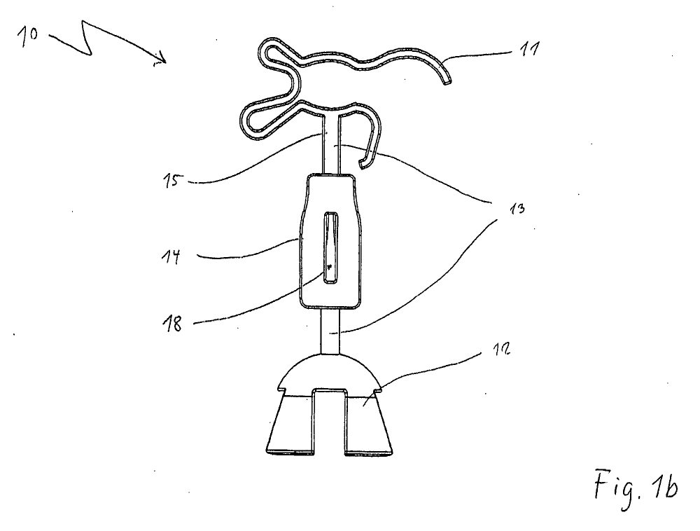

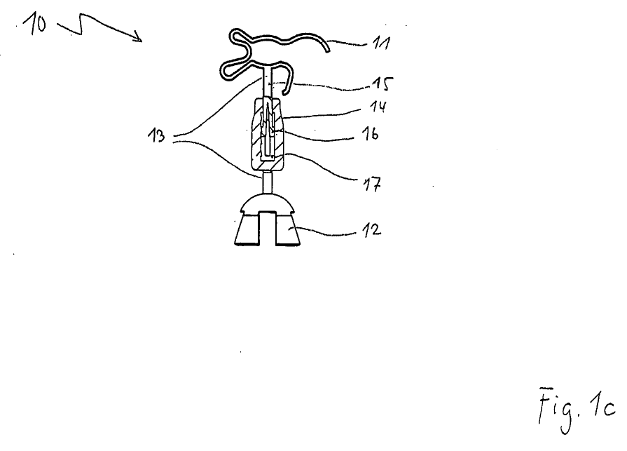

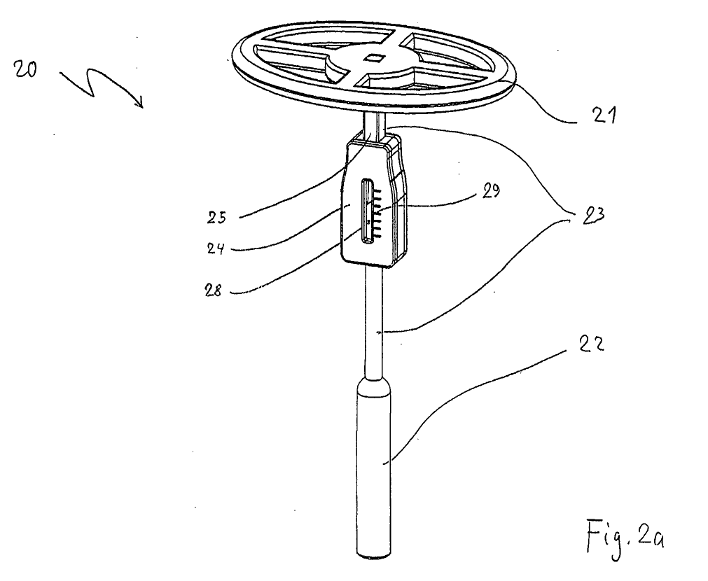

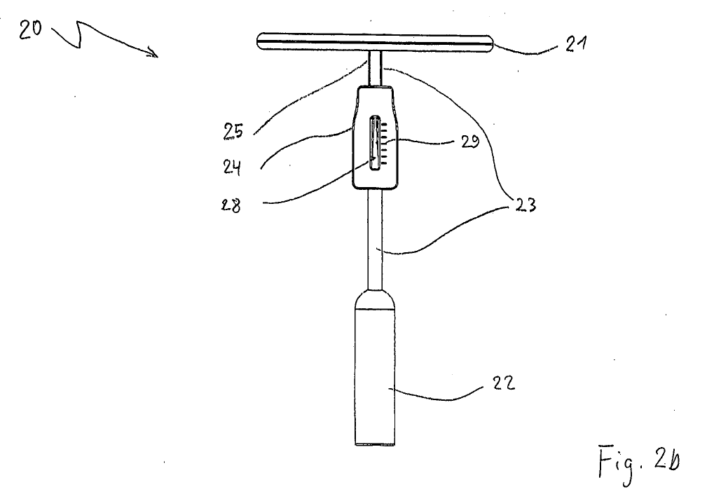

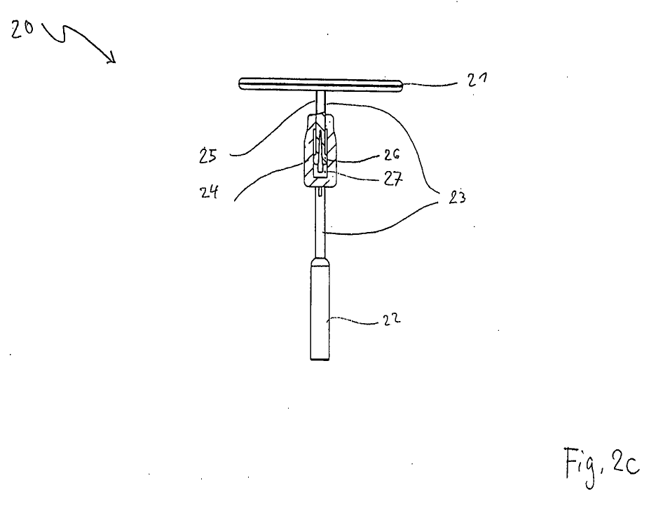

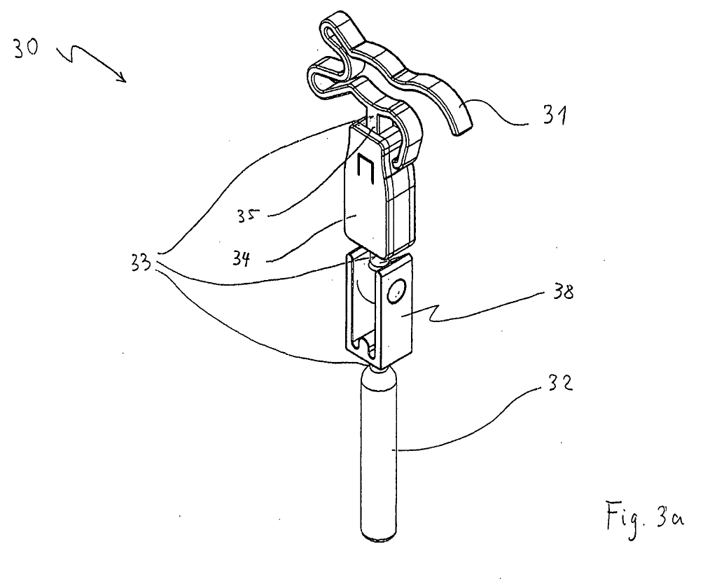

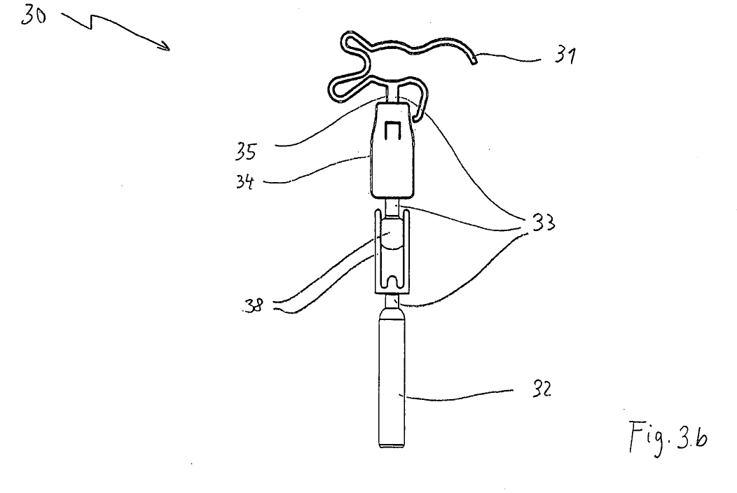

In the case of the embodiments of FIGS. 1a-2c, the receiving part 14; 24 has on at least one side an elongate window 18; 28 that runs parallel to its longitudinal axis, is formed as a clearance up to the elongate hollow space 17; 27 and, in the inserted state of the push-in part 15; 25 in the receiving part 14; 24, affords a view of the push-in part 15; 25.

In addition, in the case of the embodiment represented in FIGS. 2a-2c, a measuring scale 29 is arranged alongside the elongate window 28, parallel to the longitudinal axis of the receiving part 24, which scale comprises equidistant scale divisions running transversely to the longitudinal axis of the receiving part 24.

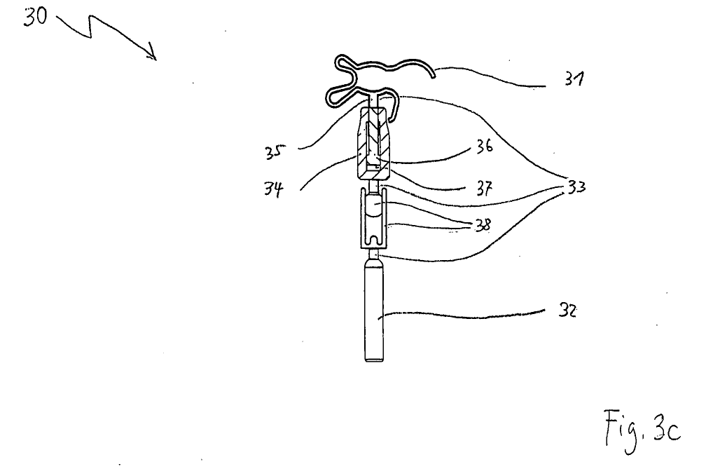

In the embodiment shown in FIGS. 3a-3c, a ball joint 38 is integrated in the connecting element 33 in order to achieve a certain postoperative flexibility of the auditory ossicle prosthesis 30 between its connecting points.

In the case of the first embodiment, shown in FIGS. 1a-1c, the first securing element 11 is formed as a clamp, which can, for example, be clipped on the process of the anvil or else on another member of the ossicular chain. The second securing element 12 is designed here in the manner of a bell and preferably serves for securing the auditory ossicle prosthesis 10 to the stirrup.

In the case of the second embodiment as shown in FIGS. 2a-2c on the other hand, the first securing element 21 is formed as a headplate for lying against the eardrum. In this exemplary embodiment, the second securing element 22 is designed at the end opposite from the headplate as a piston for the direct coupling of the auditory ossicle prosthesis 20 to the inner ear. The latter also applies to the third embodiment, represented in FIGS. 3a-3c, of an auditory ossicle prosthesis 30 according to the invention, although here, as in the case of the first embodiment as shown in FIGS. 1a-1c, the first securing element 31 is again formed as a clamp.

The mass distribution of the individual parts of the auditory ossicle prosthesis 10; 20; 30 according to the invention can be calculated in dependence on a desired, prescribable frequency response of the sound conduction in the middle ear in such a way that individual tuning of the sound conduction properties is made possible.

1. Auditory ossicle prosthesis which replaces or spans at least one member of the ossicular chain in humans, the auditory ossicle prosthesis comprising at one end a first securing element for mechanical connection to the eardrum or a member of the ossicular chain, in particular to the process of the anvil or to the manubrium of the hammer, and at its other end a second securing element for mechanical connection to a further member or parts of a member of the ossicular chain or directly to the inner ear, and also comprising an elongate connecting element, which connects the two securing elements to each other in a sound-conducting manner and has a first piece, which is formed as a receiving part, and a second piece, which is formed as a push-in part that can be pushed into a receiving opening of the receiving part coaxially in relation to the longitudinal axis of the connecting element, the first securing element being connected mechanically rigidly to one end and the second securing element being so connected to the axially opposite other end of the connecting element, the connecting element being designed so as to be variable in length in the axial direction between the receiving part and the push-in part, and the fixing of the actual axial length of the connecting element of an individual auditory ossicle prosthesis being performed by clamping the push-in part with the receiving part in a desired relative coaxial pushed-in position, characterized in that the clamping force F_{K} between the receiving part and the push-in part in the clamped state is at least 10 times, preferably approximately 100 times, greater than the maximum external forces naturally occurring in the middle ear in the region of the ossicles.

2. Auditory ossicle prosthesis according to claim 1, characterized in that the push-in part can be clamped in selectable discrete relative coaxial positions along an axial distance in engagement with the receiving part.

3. Auditory ossicle prosthesis according to claim 1, characterized in that the push-in part can be passively clamped with the receiving part by means of a spring action of the push-in part of its own and/or a spring action of the receiving part of its own.

4. Auditory ossicle prosthesis according to claim 1, characterized in that the push-in part and/or the receiving part is/are produced completely or partially from a material with shape memory (=memory effect), in particular from nitinol.

5. Auditory ossicle prosthesis according to claim 1, characterized in that the push-in part has a thickening, preferably arranged at its axial end toward the receiving part, which thickening has an ellipsoidal, in particular a rotational-ellipsoidal, preferably a spherical form.

6. Auditory ossicle prosthesis according to claim 1, characterized in that the receiving part has an elongate hollow space that is open in the direction of the push-in part and extends in the axial direction of the connecting element.

7. Auditory ossicle prosthesis according to claim 6, characterized in that the elongate hollow space of the receiving part is closed on one side in the direction away from the push-in part and thereby has an end stop for the push-in part.

8. Auditory ossicle prosthesis according to claim 6, characterized in that the elongate hollow space has a cylindrical, preferably circular-cylindrical form, or in that the elongate hollow space has a conical or pyramidal form and preferably tapers away from the push-in part in the axial direction, or in that the elongate hollow space has a rectangular cross-sectional form perpendicularly to the longitudinal axis of the receiving part.

9. Auditory ossicle prosthesis according to claim 6, characterized in that the connecting element comprises a clamping part which at least partially surrounds the receiving part in a clamping position, which corresponds to the desired relative coaxial pushed-in position between the push-in part and the receiving part, and in this clamping position at least locally constricts the inside diameter of the elongate hollow space in the receiving part.

10. Auditory ossicle prosthesis according to claim 9, characterized in that the clamping part can be pushed over the receiving part coaxially from the outside.

11. Auditory ossicle prosthesis according to claim 9, characterized in that the clamping part can be applied to the receiving part transversely to the longitudinal axis of the receiving part.

12. Auditory ossicle prosthesis according to claim 11, characterized in that the clamping part is slit continuously on one side parallel to the longitudinal axis of the receiving part.

13. Auditory ossicle prosthesis according to claim 6, characterized in that the receiving part has on at least one side an elongate window that runs parallel to its longitudinal axis, is formed as a clearance up to the elongate hollow space and, in the inserted state of the push-in part in the receiving part, affords a view of the push-in part.

14. Auditory ossicle prosthesis according to claim 13, characterized in that a measuring scale is arranged alongside the elongate window, parallel to the longitudinal axis of the receiving part, which scale comprises scale divisions, in particular equidistant scale divisions, running transversely to the longitudinal axis of the receiving part.

15. Auditory ossicle prosthesis according to claim 1, characterized in that the receiving part has a rectangular outer contour in its cross section, perpendicularly to its longitudinal axis.
